(19) United States
(12) Patent Application Publication
(10) Pub. No.: US 2015/0088637 A1
(43) Pub. Date: Mar. 26, 2015

(54) INFORMATION PROCESSING SYSTEM, INFORMATION PROCESSING METHOD, AND NON-TRANSITORY COMPUTER READABLE STORAGE MEDIUM

(71) Applicant: YAHOO JAPAN CORPORATION, Tokyo (JP)

(72) Inventors: Mitsuru MUGUCHI, Tokyo (JP); Takahumi TAMURA, Tokyo (JP); Naohiro TACHIBANA, Tokyo (JP); Chie KIKUCHI, Tokyo (JP)

(21) Appl. No.: 14/325,016

(22) Filed: Jul. 7, 2014

(30) Foreign Application Priority Data
Sep. 20, 2013 (JP) 2013-196200

(51) Int. Cl. G06Q 30/02; G06T 7/00; G06K 9/00

(52) U.S. Cl. CPC G06Q 30/0246; G06K 9/00248; G06T 7/004; G06T 2207/30201
USPC 705/14.45

(57) ABSTRACT

An information processing system includes an image acquisition unit that acquires a captured image corresponding to a field of view of a user. The information processing system includes an advertisement detection unit that detects an advertisement viewed by the user from the captured image. The information processing system includes a storage unit that stores therein information of the detected advertisement in association with the user.

### CROSS-REFERENCE TO RELATED APPLICATIONS

The present application claims priority to and incorporates by reference the entire contents of Japanese Patent Application No. 2013-196200 filed in Japan on Sep. 20, 2013.

### BACKGROUND OF THE INVENTION

1. Field of the Invention

The present invention relates to an information processing system, an information processing method, and a non-transitory computer readable storage medium.

2. Description of the Related Art

Conventionally, there is a known technology for an advertising system that measures advertising effectiveness by performing matching of persons who have viewed advertisements and persons who have used shops related to the advertisements. For example, such an advertising system includes an electronic screen provided with a camera and acquires images of faces of persons who have viewed advertising contents displayed on the electronic screen (Patent Literature 1: Japanese Laid-open Patent Publication No. 2008-102176). Furthermore, the advertising system acquires photographs of faces of persons who have visited a shop related to the advertising contents.

The advertising system compares the images of the faces of the persons who have viewed the advertising contents and the photographs of the faces of the persons who have visited the shop, and counts the number of persons who have visited the shop as a result of viewing the advertising contents. Subsequently, the advertising system evaluates the effectiveness of the advertisement based on the number of persons who have visited the shop as a result of viewing the advertising contents.

However, in the conventional technology, cameras that take images of faces of persons who have viewed advertising contents are provided on electronic screens or the like that display the advertising contents. Therefore, costs may be increased and an invasion of privacy may occur.

### SUMMARY OF THE INVENTION

It is an object of the present invention to at least partially solve the problem in the conventional technology.

According to one aspect of an embodiment of the present invention, an information processing system includes an image acquisition unit that acquires a captured image corresponding to a field of view of a user. The information processing system includes an advertisement detection unit that detects an advertisement viewed by the user from the captured image. The information processing system includes a storage unit that stores therein information of the detected advertisement in association with the user.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining an example of functions implemented by an information processing system according to an embodiment;

FIG. 2 is a diagram for explaining an example of a functional configuration of a head mounted device according to the embodiment;

FIG. 3 is a diagram for explaining an example of a functional configuration of a processing server according to the embodiment;

FIG. 4 is a diagram for explaining an example of information stored in an advertisement database according to the embodiment;

FIG. 5 is a diagram for explaining an example of information stored in a shop database according to the embodiment;

FIG. 6 is a diagram for explaining an example of information stored in an advertisement view table according to the embodiment;

FIG. 7 is a diagram for explaining an example of information stored in a shop usage table according to the embodiment;

FIG. 8 is a diagram for explaining a process of detecting a shop by a processing server according to the embodiment;

FIG. 9 is a diagram for explaining a modified example of a process of detecting an advertisement viewed by a user;

FIG. 10 is a flowchart for explaining the flow of a detection process performed by the information processing system according to the embodiment;

FIG. 11 is a flowchart for explaining the flow of matching performed by the information processing system according to the embodiment; and

FIG. 12 is a diagram illustrating an example of a hardware configuration of a computer that executes an information processing program.

### DETAILED DESCRIPTION OF THE PREFERRED EMBODIMENTS

Preferred embodiments (hereinafter, referred to as “embodiments”) of an information processing system, an information processing method, and a non-transitory computer readable storage medium will be described in detail below with reference to drawings. The information processing system, the information processing method, and the non-transitory computer readable storage medium are not limited by the embodiments. In each of the embodiments below, the same components are denoted by the same reference numerals and symbols, and the same explanation will be omitted.

### 1. Information Processing System

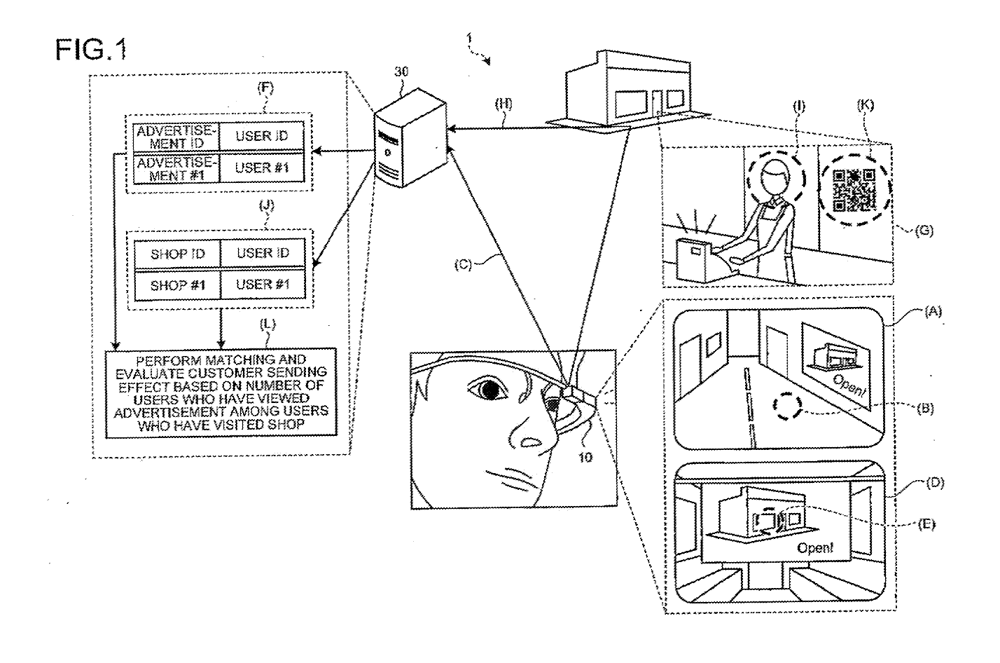

An example of a process performed by an information processing system according to an embodiment will be described with reference to FIG. 1. FIG. 1 is a diagram for explaining an example of functions implemented by the information processing system according to the embodiment. In the example illustrated in FIG. 1, an information processing system 1 includes a head mounted device 10 and a processing server 30 that are connected to each other via an arbitrary network, such as the Internet. The information processing system 1 also includes a plurality of other head mounted devices.

The head mounted device 10 is a wearable device that acquires a subjective image that is a captured image obtained by capturing an image of the field of view of a user. For example, the head mounted device 10 is a glass-type device. The head mounted device 10 can display arbitrary information in the visual field of the user. The head mounted device 10 includes a camera and can capture subjective images. The head mounted device 10 catches the movement of the eyeball of a user #1 by using, for example, infrared or the like, and can determine which area in the visual field is viewed by the user #1, that is, to where the line of sight is directed.

The head mounted device 10 can be connected to the network via a wireless communication network, such as 3rd generation (3G), 4th generation (4G), Long-Term Evolution (LTE), or Global System for Mobile Communications (GSM) (registered trademark). The head mounted device 10 may be connected to a terminal device, such as a mobile phone (not illustrated), by using near field wireless communication, such as Bluetooth (registered trademark) or a wireless local area network (LAN), and may be connected to the network via the connected terminal device.

The head mounted device 10 may be implemented by a plurality of devices that cooperate with one another as long as they are configured to implement the same functions. For example, the head mounted device 10 may be realized by a combination of a subjective image acquisition device that captures subjective images and a terminal device that performs near field wireless communication with the subjective image acquisition device and that transmits the subjective images to the processing server 30. The terminal device need not include a function of displaying images in the visual field of the user unlike the head mounted device 10, and only needs to include a screen for displaying arbitrary information.

The head mounted device 10 performs processes as described below. First, the head mounted device 10 acquires a subjective image at predetermined time intervals. The head mounted device 10 generates line-of-sight information indicating to where the line of sight of the user is directed in the subjective image. Then, the head mounted device 10 transmits the subjective image and the line-of-sight information to the processing server 30. This process may be performed continuously or may be performed at predetermined time intervals.

Meanwhile, the processing server 30 detects a predetermined advertisement from the subjective image received from the head mounted device 10. The advertisement is not limited to information displayed on objects, such as electronic screens or signboards, placed in public spaces. For example, the advertisement includes moving images such as commercials, information appearing in newspapers or magazines, information provided on exteriors of goods, digital signages, various advertisements such as banners displayed on Web browsers, mannequins or goods of mascot characters, advertised goods themselves, and the like.

For example, the processing server 30 detects an advertisement from the subjective image received from the head mounted device 10 by using advertisement detection data that is information for detecting an advertisement from the subjective image. The advertisement detection data is, for example, a feature vector for recognizing a specific color, shape, pattern, or the like from an image. The processing server 30 detects an advertisement from the subjective image by using an image recognition technique using the feature vector. If a quick response (QR) code (registered trademark) or an invisible dot pattern is contained in an advertisement and it is possible to detect the advertisement by using the QR code or the dot pattern, the processing server 30 may detect the advertisement without using the advertisement detection data.

When detecting an advertisement from the subjective image received from the head mounted device 20, the processing server 30 determines that the user of the head mounted device 10 has viewed the detected advertisement. Then, the processing server 30 stores information indicating that the user has viewed the advertisement. For example, when detecting an advertisement from the subjective image received from the head mounted device 10, the processing server 30 stores therein identification information on the user of the head mounted device 10 and identification information on the detected advertisement in an associated manner.

The processing server 30 may determine whether the user has viewed an advertisement by using the line-of-sight information acquired by the head mounted device 10. For example, when detecting an advertisement from the subjective image, the processing server 30 specifies an area containing the detected advertisement in the subjective image. Then, if a line-of-sight position indicated by the line-of-sight information is contained within the specified area, the processing server 30 may determine that the user has viewed the advertisement.

Furthermore, the processing server 30 may specify an area containing an advertisement and acquire line-of-sight positions indicated by line-of-sight information for a plurality of subjective images that are sequentially acquired, and if the line-of-sight positions indicated by the line-of-sight information have been contained within the specified area for a longer time than a predetermined time, the processing server 30 may determine that the user has viewed the advertisement. Moreover, the processing server 30 may divide an area containing an advertisement into a plurality of areas, and if the line-of-sight positions are contained in all of the areas, the processing server 30 may determine that the user has viewed the advertisement. Furthermore, if the user has viewed each of parts of the same type of an advertisement provided in different locations and therefore viewed the entire area of the advertisement within a predetermined time, the processing server 30 may determine that the user has viewed the advertisement.

Subsequently, the processing server 30 detects a shop visited by the user from the subjective image received from the head mounted device 10 by using shop detection data that is information for detecting a shop visited by the user from the subjective image. The shop detection data is, for example, a feature vector for detecting inside of a shop from an image. The processing server 30 detects a shop visited by the user from the image by using the feature vector. If information, such as a QR code, for identifying a shop is provided inside the shop, the processing server 30 may detect the shop visited by the user of the head mounted device 10 by detecting the information from the subjective image.

When detecting a shop from the subjective image received from the head mounted device 10, the processing server 30 determines that the user of the head mounted device 10 has visited the detected shop. Then, the processing server 30 stores information indicating that the user has visited the shop. For example, when detecting a shop from the subjective image received from the head mounted device 10, the processing server 30 stores identification information on the user of the head mounted device 10 and identification information on the detected shop in an associated manner.

The processing server 30 may employ arbitrary information as the shop detection data as long as the information can detect that the user has visited the shop. For example, the processing server 30 stores, as the shop detection data, data for performing face authentication, and detects a face of a shop staff from the subjective image by using the stored data. When detecting a face of a shop staff from the subjective image, the processing server 30 may determine that the user has visited a shop in which the shop staff works.

Subsequently, the processing server 30 performs matching of the advertisement viewed by the user and the shop visited by the user, and determines whether the advertisement induced the user to visit a shop associated with the advertisement. The shop associated with the advertisement is a shop that has a predetermined relation with the advertisement, such as a shop featured in the advertisement or a shop that sells goods or provides services related to the advertisement.

Furthermore, the processing server 30 performs a predetermined process related to the advertisement by using information on the user who has been induced to visit the shop by the advertisement, information on the shop visited by the user, or the like. For example, the processing server 30 counts the total number of users who have visited a certain shop based on the information on the shop visited by the user. Then, the processing server 30 calculates an effect of sending customer by the advertisement based on a ratio of the number of users who have been induced to visit the shop by the advertisement to the total number of users who have visited the shop.

The process server 30 may charge an advertisement fee for a certain advertisement based on information on users who have been induced to visit a shop by the advertisement. For example, the processing server 30 performs the above described process and calculates, for each advertisement, the number of users who have been induced to visit a shop by each advertisement. Then, the processing server 30 calculates an advertisement fee for each advertisement according to the number of the users who have been induced to visit the shop by each advertisement, and charges the calculated advertisement fee. For example, the processing server 30 calculates, as the advertisement fee, a product of an advertisement fee for each user who has been induced visit the shop by the advertisement and the number of the users who have been induced to visit the shop by the advertisement.

By performing the above described process, the processing server 30 can effectively charge the advertisement fees. Incidentally, the processing server 30 need not perform the process of charging the advertisement fees based on the number of the users who have been induced to visit the shop, and, for example, may notify a system that charges the advertisement fees of the number of the users who have been induced to visit the shop by each advertisement.

As described above, the information processing system 1 acquires a subjective image of the user, detects an advertisement from the acquired subjective image, and stores the identification information on the detected advertisement and the identification information on the user in an associated manner. Accordingly, the information processing system 1 can specify a user who has viewed the advertisement without performing face authentication on the user who has viewed the advertisement; therefore, it becomes possible to prevent an invasion of privacy. Furthermore, the information processing system 1 need not provide, in advertisements, cameras that capture images of faces of users; therefore, it becomes possible to reduce costs.

Moreover, the information processing system 1 can specify whether users have viewed advertisements with respect to not only advertisements in which cameras can be provided, but also advertisements such as advertisements in magazines, newspapers, or the like, or goods themselves in which it is difficult to provide cameras. Therefore, the information processing system 1 can evaluate the effectiveness of arbitrary advertisements viewed by the users.

For example, the information processing system 1 can evaluate the advertising effectiveness of a new vehicle itself based on the number of users who have visited a dealer of the vehicle from among users who have viewed the new vehicle on the street, that is, based on the number of users who have been induced to visit the dealer by the advertisement. Incidentally, the information processing system 1 may evaluate the advertising effectiveness by taking into account age, sex, or the like of users who have been induced to visit a shop by the advertisement. For example, the information processing system 1 may evaluate a type of users for which the advertisement can be effective, based on age or sex of users who have been induced to visit the shop by the advertisement.

Next, the flow of a process performed by the information processing system 1 will be described. In the explanation below, it is assumed that the information processing system 1 determines that a user has viewed an advertisement when the advertisement is detected from a subjective image of the user and when the advertisement and a line-of-sight position of the user match with each other. Furthermore, in the explanation below, a shop featured in the advertisement is described as an advertised shop.

First, the head mounted device 10 acquires a subjective image illustrated in (A) in FIG. 1 and line-of-sight information illustrated in (B) in FIG. 1, and transmits the subjective image and the line-of-sight information to the processing server 30 as illustrated in (C) in FIG. 1. In the example illustrated in (A) in FIG. 1, an advertisement that indicates opening of a new shop and that is provided in the street is contained, but the line of sight of the user is not contained in an area containing the advertisement in the subjective image as illustrated in (B) in FIG. 1. In this case, the processing server 30 determines that the user has not viewed the advertisement.

Meanwhile, the head mounted device 10 transmits a subjective image illustrated in (D) in FIG. 1 and line-of-sight information illustrated in (E) in FIG. 1 to the processing server 30. In the example illustrated in (D) in FIG. 1, an advertisement indicating opening of a new shop is contained in an advertisement on train, and the line of sight of the user is contained in an area containing the advertisement in the subjective image as illustrated in (E) in FIG. 1. In this case, the processing server 30 determines that the user has viewed the advertisement, and stores, as illustrated in (F) in FIG. 1, an advertisement identifier (ID) of “advertisement #1”, which is the identification information on the advertisement, and a user ID of “user #1”, which is the identification information on the user of the head mounted device 10, in an associated manner.

Furthermore, when the user visits the advertised shop, the head mounted device 10 acquires a subjective image illustrated in (G) in FIG. 1, and transmits the subjective image illustrated in (G) in FIG. 1 to the processing server 30 as illustrated in (H) in FIG. 1. In this case, the processing server 30 performs face authentication on a shop staff of the advertised shop from the subjective image illustrated in (G) in FIG. 1 and determines whether the user has visited the advertised shop. As illustrated in (I) in FIG. 1, the subjective image contains a face of a shop staff of the advertised shop. Therefore, the processing server 30 performs a face authentication process from the subjective image, and when succeeding in face authentication on the shop staff, determines that the user has visited the advertised shop. Then, the processing server 30 stores, as illustrated in (J) in FIG. 1, a shop ID of “shop #1”, which is identification information on the advertised shop visited by the user and the user ID of “user #1” in an associated manner.

If, as illustrated in (K) in FIG. 1, a QR code or the like indicating the shop ID of “shop #1” is displayed in the shop, the processing server 30 can determine whether the user has visited the advertised shop without performing face authentication. Therefore, when detecting the QR code for identifying the shop from the subjective image, the processing server 30 stores the shop ID of “shop #1” indicated by the detected QR code and the user ID of “user #1” in an associated manner.

Thereafter, as illustrated in (L) in FIG. 1, the processing server 30 performs matching of a combination of the advertisement ID and the user ID and a combination of the shop ID and the user ID, and calculates the number of users who have been induced to visit the shop by the advertisement among users who have visited the shop. For example, if an advertisement indicated by the advertisement ID of “advertisement #1” is an advertisement of the shop indicated by the shop ID of “shop #1”, the processing server 30 determines that the user indicated by the user ID of “user #1” is a user who has visited the shop as a result of viewing the advertisement corresponding to the shop ID of “shop #1”, that is, a user who has been induced to visit the shop by the advertisement. Then, the processing server 30 evaluates the effect of sending customer by the advertisement based on the calculated number of users.

Incidentally, the processing server 30 may determine whether the user has been induced to visit the shop by the advertisement according to a time at which the user viewed the advertisement and a time at which the user visited the advertised shop. For example, if the user visited the advertised shop featured in the advertisement before having viewed the advertisement, the processing server 30 may determine that the user has not been induced to visit the shop by the advertisement. Furthermore, for example, if a difference between the date and time at which the user viewed the advertisement and the date and time at which the user visited the advertised shop is greater than a threshold (for example, about a few days), the processing server 30 may determine that the user has not been induced to visit the shop by the advertisement.

As described above, the information processing system 1 detects an advertisement from a subjective image of the user. Furthermore, the information processing system 1 detects a shop visited by the user from the subjective image of the user. Then, the information processing system 1 determines whether the user has been induced to visit the shop by the advertisement by using a result of the detection of the advertisement and a result of the detection of the shop. Subsequently, the information processing system 1 evaluates the effect of sending customer by the advertisement by using a result of the determination. Therefore, the information processing system 1 can evaluate the effect of sending customer by the advertisement while preventing an invasion of privacy and an increase in costs.

In the above described example, it is explained that the head mounted device 10 acquires the subjective image of the user and transmits the acquired subjective image to the processing server 30, and the processing server 30 detects an advertisement from the subjective image, detects a shop, and determines whether the user has been induced to visit the shop by the advertisement. However, the embodiment is not limited to this example. Namely, the above described process may be performed by either the head mounted device 10 or the processing server 30.

### 2. Functional Configuration of Head Mounted Device

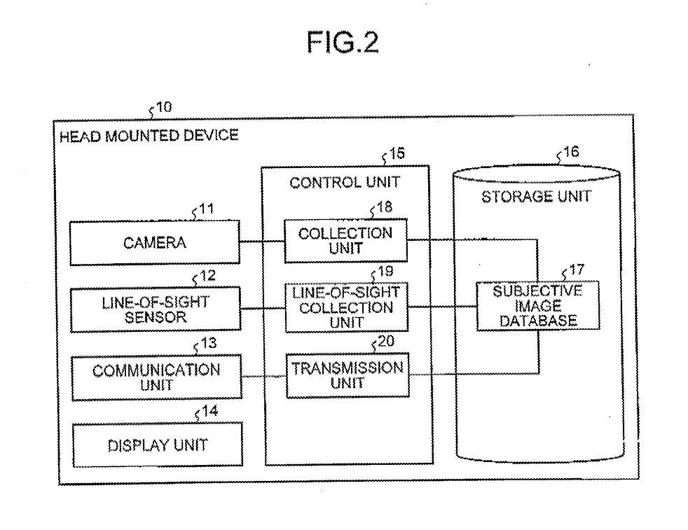

A functional configuration of the head mounted device 10 according to the embodiment will be described below with reference to FIG. 2. FIG. 2 is a diagram for explaining an example of the functional configuration of the head mounted device according to the embodiment. In the example illustrated in FIG. 2, the head mounted device 10 includes a camera 11, a line-of-sight sensor 12, a communication unit 13, a display unit 14, a control unit 15, and a storage unit 16. The storage unit 16 stores therein a subjective image database 17. The control unit 15 includes a collection unit 18, a line-of-sight collection unit 19, and a transmission unit 20.

First, a subjective image database 17 stored in the storage unit 16 will be described. The subjective image database 17 is a storage unit for temporarily storing a subjective image and line-of-sight information, which are acquired at the same time, in an associated manner, and serves as a so-called cache area.

The camera 11 is an image acquisition device that acquires subjective images. For example, the camera 11 is an image acquisition device attached beside the eye of a user and acquires subjective images of the user who is wearing the head mounted device 10, by using a charge coupled device (CCD) image sensor or a complementary metal-oxide semiconductor (CMOS) image sensor. The line-of-sight sensor 12 catches movement of the eyeball of the user by using infrared or the like, and specifies which area in the subjective image is viewed by the user.

The communication unit 13 controls communication between the head mounted device 10 and the processing server 30. Specifically, when receiving an image log that is a combination of a subjective image and line-of-sight information from the transmission unit 20, the communication unit 13 transmits the received image log to the processing server 30.

The display unit 14 is a display device that can display arbitrary information in the field of views of the user. For example, the display unit 14 inputs an image to a free-form surface prism placed on the line of sight of the user, to thereby display information in the field of view of the user. For example, the display unit 14 can display arbitrary information, such as information on a person contained in a Web browser or in the field of view of the user or an augmented reality (AR) tag, in the field of view of the user.

Next, a process performed by the control unit 15 will be described. The collection unit 18 operates the camera 11 and collects a subjective image acquired by the camera 11 at predetermined time intervals. Then, the collection unit 18 stores the collected subjective image in the subjective image database 17. A timestamp indicating a date and time at which the subjective image is captured is added to the subjective image acquired by the control unit 15. A time interval at which the collection unit 18 collects the subjective image may be determined arbitrarily, for example, may be set to a rate such as one image per few seconds.

The line-of-sight collection unit 19 operates the line-of-sight sensor 12 and acquires a line-of-sight position of the user when the collection unit 18 collects the subjective image. Then, the line-of-sight collection unit 19 generates line-of-sight information indicating the line-of-sight position, and stores the generated line-of-sight information in the subjective image database 17 in association with the subjective image acquired by the collection unit 18.

The transmission unit 20 transmits an image log stored in the subjective image database 17 to the processing server 30. For example, the transmission unit 20 reads the image log stored in the subjective image database 17 at predetermined time intervals, adds the user ID indicating the user of the head mounted device 10 to the read image log, and outputs the image log to the communication unit 13.

### 3. Functional Configuration of Processing Server 30

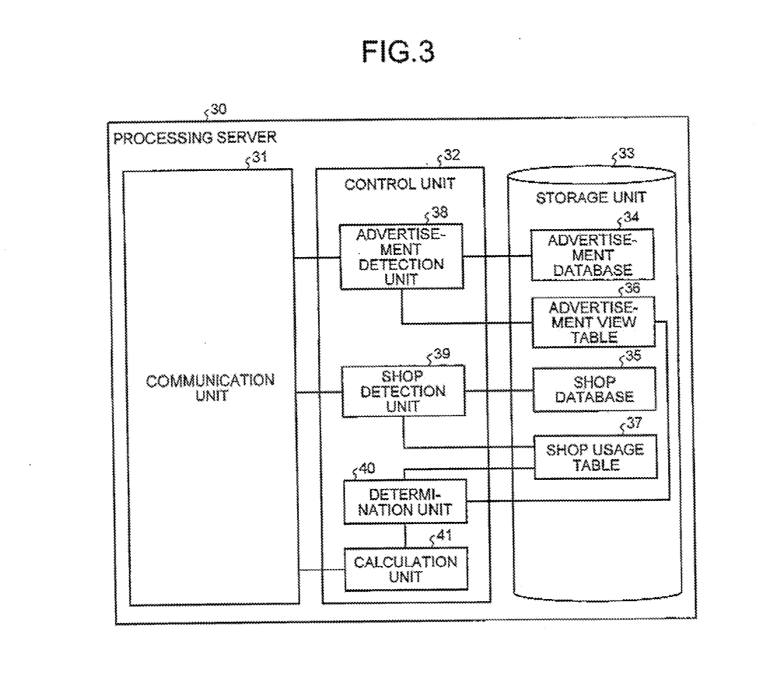

A functional configuration of the processing server 30 according to the embodiment will be described below with reference to FIG. 3. FIG. 3 is a diagram for explaining an example of the functional configuration of a processing server according to the embodiment. In the example illustrated in FIG. 3, the processing server 30 includes a communication unit 31, a control unit 32, and a storage unit 33. The storage unit 33 includes an advertisement database 34, a shop database 35, an advertisement view table 36, and a shop usage table 37. The control unit 32 includes an advertisement detection unit 38, a shop detection unit 39, a determination unit 40, and a calculation unit 41.

First, information stored in the advertisement database 34, the shop database 35, the advertisement view table 36, and the shop usage table 37 stored in the storage unit 33 will be described.

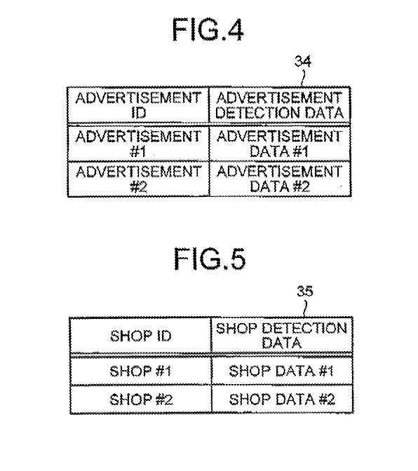

The advertisement database 34 stores therein the advertisement detection data for detecting an advertisement from a subjective image, in association with an advertisement ID. For example, FIG. 4 is a diagram for explaining an example of the information stored in the advertisement database according to the embodiment. For example, the advertisement database 34 stores therein, as illustrated in FIG. 4, the advertisement ID and the advertisement detection data in an associated manner.

A detailed example will be described below. The advertisement database 34 stores therein the advertisement ID of “advertisement #1” and advertisement detection data of “advertisement data #1”, which is a feature vector for detecting an advertisement indicated by the advertisement ID of “advertisement #1” from a subjective image, in an associated manner. Furthermore, the advertisement database 34 stores therein an advertisement ID of “advertisement #2” and advertisement detection data of “advertisement data #2”, which is a feature vector for detecting an advertisement indicated by the advertisement ID of “advertisement #2” from a subjective image, in an associated manner.

Referring back to FIG. 3, the explanation is continued. The shop database 35 stores therein the shop detection data for detecting a shop visited by user from a subjective image, in association with the shop ID. For example, FIG. 5 is a diagram for explaining an example of the information stored in the shop database according to the embodiment. For example, as illustrated in FIG. 5, the shop database 35 stores therein the shop ID and the shop detection data in an associated manner.

A detailed example will be described below. The shop database 35 stores therein the shop ID of “shop #1” and shop detection data of “shop data #1”, which is face authentication data for specifying a shop staff of a shop indicated by the shop ID of “shop #1”, in an associated manner. Furthermore, the shop database 35 stores therein a shop ID of “shop #2” and shop detection data of “shop data #2”, which is face authentication data for specifying a shop staff of a shop indicated by the shop ID of “shop #2”, in an associated manner. The shop detection data may contain pieces of data for performing face authentication on respective shop staffs.

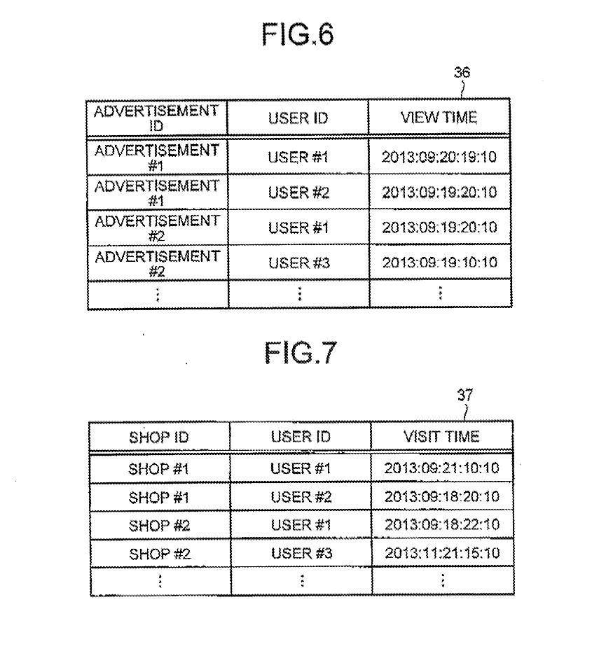

Referring back to FIG. 3, the explanation is continued. The advertisement view table 36 stores therein the user ID of a user who is determined to have viewed the advertisement, an advertisement ID of the viewed advertisement, and a view time that is a date and time at which the user viewed the advertisement, in an associated manner. For example, FIG. 6 is a diagram for explaining an example of the information stored in the advertisement view table according to the embodiment.

For example, in the example illustrated in FIG. 6, the advertisement view table 36 stores therein the advertisement ID of “advertisement #1”, the user ID of “user #1”, and a view time of “2013:09:20:19:10” in an associated manner. This entry indicates that, in the advertisement view table 36, the user indicated by the user ID of “user #1” viewed the advertisement indicated by the advertisement ID of “advertisement #1” on Sep. 20, 2013, at 19:10.

Furthermore, for example, in the example illustrated in FIG. 6, the advertisement view table 36 stores therein the advertisement ID of “advertisement #1”, a user ID of “user #2”, and a view time of “2013:09:19:20:10” in an associated manner. Moreover, the advertisement view table 36 stores therein the advertisement ID of “advertisement #2”, the user ID of “user #1”, and a view time of “2013:09:19:20:10” in an associated manner. Furthermore, the advertisement view table 36 stores therein the advertisement ID of “advertisement #2”, a user ID of “user #3”, and a view time of “2013:09:19:10:10” in an associated manner.

Referring back to FIG. 3, the explanation is continued. The shop usage table 37 stores therein a shop ID of a shop visited by the user, a user ID of the user who has visited the shop, and a shop visit time that is a date and time at which the user visited the shop, in an associated manner. For example, FIG. 7 is a diagram for explaining an example of the information stored in the shop usage table according to the embodiment.

For example, in the example illustrated in FIG. 7, the shop usage table 37 stores therein the shop ID of “shop #1”, the user ID of “user #1”, and a shop visit time of “2013:09:21:10:10” in an associated manner. This entry indicates that the user indicated by the user ID of “user #1” visited the shop indicated by the shop ID of “shop #1” on Sep. 21, 2013, at 10:10.

Furthermore, for example, in the example illustrated in FIG. 7, the shop usage table 37 stores therein the shop ID of “shop #1”, the user ID of “user #2”, and a shop visit time of “2013:09:18:20:10” in an associated manner. Moreover, the shop usage table 37 stores therein the shop ID of “shop #2”, the user ID of “user #1”, and a shop visit time of “2013:09:18:22:10” in an associated manner. Furthermore, the shop usage table 37 stores therein the shop ID of “shop #2”, the user ID of “user #3”, and a shop visit time of “2013:11:21:15:10” in an associated manner.

In the explanation below, it is assumed that the shop indicated by the shop ID of “shop #1” is an advertised shop in the advertisement indicated by the advertisement ID of “advertisement #1”, the shop indicated by the shop ID of “shop #2” is an advertised shop in the advertisement indicated by the advertisement ID of “advertisement #2”, and the shop indicated by the shop ID of “shop #3” is an advertised shop in the advertisement indicated by the advertisement ID of “advertisement #3”. The embodiment is not limited to this example. For example, it may be possible to set a plurality of advertisements for a single shop as an advertised shop. In this case, a plurality of advertisement IDs are associated with a single shop ID.

Referring back to FIG. 3, the explanation is continued. The communication unit 31 controls communication between the processing server 30 and the head mounted device 10. For example, when receiving an image log from the head mounted device 10 via the network, the communication unit 31 outputs the received image log to the advertisement detection unit 38 and the shop detection unit 39.

The advertisement detection unit 38 detects an advertisement viewed by the user from the subjective image. For example, upon receiving the image log from the communication unit 31, the advertisement detection unit 38 acquires the subjective image, the line-of-sight information, and the user ID from the received image log. Furthermore, the advertisement detection unit 38 acquires a timestamp from the subjective image.

Subsequently, the advertisement detection unit 38 performs an image recognition process by using all pieces of the advertisement detection data stored in the advertisement database 34, and detects an advertisement from the subjective image. Furthermore, when detecting the advertisement, the advertisement detection unit 38 extracts an area containing the advertisement from the subjective image, and determines whether a line-of-sight position indicated by the line-of-sight information is contained in the extracted area. When the line-of-sight position indicated by the line-of-sight information is contained in the extracted area, the advertisement detection unit 38 determines that the advertisement contained in this area is an advertisement that has been viewed by the user. Thereafter, the advertisement detection unit 38 stores, in the advertisement view table 36, the user ID acquired from the subjective image, the advertisement ID indicating the advertisement viewed by the user, the timestamp acquired from the subjective image in an associated manner.

For example, it is assumed that the advertisement detection unit 38 has acquired the user ID of “user ID” and a view time of “2013:09:20:19:10” from the subjective image. Furthermore, it is also assumed that the advertisement detection unit 38 has detected the advertisement indicated by the advertisement ID of “advertisement #1” from the subjective image and the advertisement indicated by the advertisement ID of “advertisement #2” from the subjective image. In this case, the advertisement detection unit 38 extracts areas containing the respective advertisements, and determines whether the line-of-sight position indicated by the line-of-sight information acquired from the image log is contained in any of the extracted areas.

When the line-of-sight position is contained in the area containing the advertisement indicated by the advertisement ID of “advertisement #1”, the advertisement detection unit 38 stores the advertisement ID of “advertisement #1”, the user ID of “user ID”, and the view time of “2013:09:20:19:10” in the advertisement view table 36 in an associated manner. In contrast, when the line-of-sight position is not contained in the area containing the advertisement indicated by the advertisement ID of “advertisement #1” and in the area containing the advertisement indicated by the advertisement ID of “advertisement #2”, the advertisement detection unit 38 determines that the user has not viewed the advertisements, and discards the acquired image log.

The shop detection unit 39 detects a shop visited by the user from the subjective image. For example, upon receiving an image log from the communication unit 31, the shop detection unit 39 acquires the subjective image, the line-of-sight information, and the user ID from the received image log. Furthermore, the shop detection unit 39 acquires a timestamp from the subjective image. Then, the shop detection unit 39 performs an image recognition process by using all pieces of the shop detection data stored in the shop database 35, and detects a shop from the subjective image.

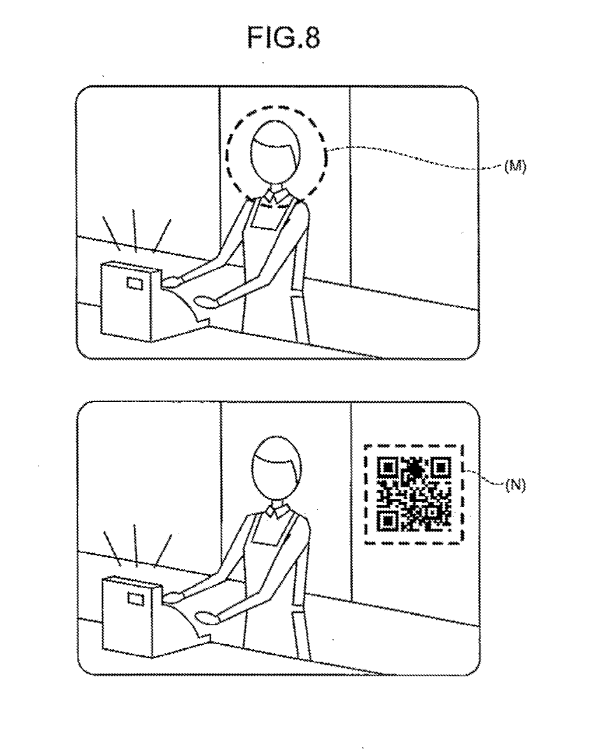

For example, FIG. 8 is a diagram for explaining a process of detecting a shop by the processing server according to the embodiment. For example, if the shop detection data is data for performing face authentication on a shop staff, the shop detection unit 39 detects a face of a person from the subjective image of the user as illustrated in (M) in FIG. 8, and performs face authentication on the detected face by using the data for performing the face authentication on a shop staff. If the face authentication on the detected face is successful, that is, if the detected face is the face of the shop staff, the shop detection unit 39 determines that the user has visited the shop associated with the shop staff. Furthermore, if the detected face is the face of the shop staff, the shop detection unit 39 specifies a shop ID associated with the data for performing the face authentication on a shop staff. Then, the shop detection unit 39 stores the specified shop ID, the user ID acquired from the subjective image, the timestamp acquired from the subjective image in the shop usage table 37 in an associated manner.

Furthermore, for example, as illustrated in (N) in FIG. 8, if information indicating the shop, such as a QR code indicating the shop, is provided inside the shop or behind a cash register for example, the shop detection unit 39 can detect the shop visited by the user without using the shop detection data. For example, when detecting a QR code as illustrated in (N) in FIG. 8 in the subjective image, the shop detection unit 39 extracts the shop ID from the detected QR code, and stores the extracted shop ID, the user ID acquired from the subjective image, and the timestamp acquired from the subjective image in the shop usage table 37 in an associated manner.

Referring back to FIG. 3, the determination unit 40 performs matching of the advertisement view table 36 and the shop usage table 37, and determines whether the advertisement detected by the advertisement detection unit 38 is a related advertisement detected by the shop detection unit 39. When determining that the advertisement is related to the shop detected by the shop detection unit 39, the determination unit 40 determines whether the view time is earlier than the shop visit time. If the view time is earlier than the shop visit time, the determination unit 40 determines that the user has been induced to visit the advertised shop.

As an example of processes performed by the determination unit 40, an example will be described below, in which the information illustrated in FIG. 6 is stored in the advertisement view table 36 and the information illustrated in FIG. 7 is stored in the shop usage table 37. For example, the determination unit 40 acquires, as combinations of the advertisement IDs and the view times associated with the user ID of “user #1”, a combination of the advertisement ID of “advertisement #1” and the view time of “2013:09:20:19:10” and a combination of the advertisement ID of “advertisement #2” and the view time of “2013:09:19:20:10” from the advertisement table 36.

Furthermore, the determination unit 40 acquires, as combinations of the shop IDs and the shop visit times associated with the user ID of “user #1”, a combination of the shop ID of “shop #1” and the shop visit time of “2013:09:21:10:10” and a combination of the shop ID of “shop #2” and the shop visit time of “2013:09:18:22:10” from the shop usage table 37.

The advertisement indicated by the advertisement ID of “advertisement #1” is an advertisement that contains the shop indicated by the shop ID of “shop #1” as an advertised shop. Therefore, the determination unit 40 determines whether the view time of “2013:09:20:19:10” associated with the advertisement ID of “advertisement #1” is earlier than the shop visit time of “2013:09:21:10:10” associated with the shop ID of “shop #1”.

In the above described example, the view time of “2013:09:20:19:10” is earlier than the shop visit time of “2013:09:21:10:10”. Therefore, the determination unit 40 determines that the advertisement indicated by the advertisement ID of “advertisement #1” induced the user indicated by the user ID of “user #1” to visit the shop indicated by the shop ID of “shop #1”. Thereafter, the determination unit 40 outputs, to the calculation unit 41, information indicating that the advertisement indicated by the advertisement ID of “advertisement #1” induced the user indicated by the user ID of “user #1” to visit the shop indicated by the shop ID of “shop #1”.

Meanwhile, the advertisement indicated by the advertisement ID of “advertisement #2” is an advertisement that contains the shop indicated by the shop ID of “shop #2” as an advertised shop. Therefore, the determination unit 40 determines whether the view time of “2013:09:19:20:10” associated with the advertisement ID of “advertisement #2” is earlier than the shop visit time of “2013:09:18:22:10” associated with the shop ID of “shop #1”.

In the above described example, the view time of “2013:09:19:20:10” is later than the shop visit time of “2013:09:18:22:10”. Therefore, the determination unit 40 determines that the advertisement indicated by the advertisement ID of “advertisement #2” has not induced the user indicated by the user ID of “user #1” to visit the shop indicated by the shop ID of “shop #2”, and ends the process without sending a notice to the calculation unit 41.

Furthermore, the determination unit 40 performs the above described process with respect to each user ID, and notifies the calculation unit 41 of a user who has been induced to visit the shop by each advertisement. Moreover, the determination unit 40 sorts the shop usage table 37 by the shop ID, and calculates the total number of users who have visited each shop. Then, the determination unit 40 notifies the calculation unit 41 of a result of the calculation.

The calculation unit 41 calculates, for each shop, the effect of sending customer by the advertisement based on the number of users who have visited the shop and the number of user who have been induced to visit the shop by the advertisement containing the shop as an advertised shop. Then, the calculation unit 41 provides the advertiser or a provider of the advertisement with the effect of sending customer by the advertisement.

For example, the calculation unit 41 receives, from the determination unit 40, the number of users who have been induced to visit a shop by each advertisement and the total number of users who have visited each shop. In this case, the calculation unit 41 calculates, for each advertised shop, the number of users who have been induced by the advertisement by using the number of the users who have been induced to visit the shop by each advertisement. Then, the calculation unit 41 calculates a value indicating the effect of sending customer by the advertisement based on the total number of the users who have visited the shop and based on the number of the users who have been induced by the advertisement containing the shop as an advertised shop. Thereafter, the calculation unit 41 provides an advertiser or a provider of the advertisement with the calculated value. Furthermore, the calculation unit 41 calculates an advertisement fee charged for the advertisement based on the number of the users who have been induced by the advertisement, and notifies an advertiser, a provider of the advertisement, a system that charges the advertisement fee, or the like of the calculated advertisement fee.

### 4. Modified Example of Processes Performed by the Information Processing System 1

In the above descriptions, when the line-of-sight position indicated by the line-of-sight information is contained in an area of an advertisement contained in the subjective image, the information processing system 1 determines that the user has viewed the advertisement. Furthermore, the information processing system 1 performs face authentication on a person and a shop staff contained in the subjective image to detect a shop visited by the user. Moreover, when the view time at which the advertisement was viewed is earlier than a visit time at which the user visited the shop that is an advertised shop in the advertisement, the information processing system 1 determines that the advertisement induced the user to visit the advertised shop. However, the embodiment is not limited to this example. In the following, modified examples of the process performed by the information processing system 1 will be described.

### 4-1. Modified Example of Process of Detecting Advertisement Viewed by User

For example, the information processing system 1 may detect an advertisement contained in the subjective image of the user as an advertisement viewed by the user without taking into account the line-of-sight information. Furthermore, the information processing system 1 determines, by using a plurality of sequentially acquired subjective images and pieces of line-of-sight information, whether the line-of sight positions indicated by the line-of-sight information have been contained in areas of an advertisement in the subjective images for a predetermined time. Then, when determining that the line-of-sight positions indicated by the line-of-sight information have been contained in the areas of the advertisement in the subjective images for the predetermined time, the information processing system 1 may determine that the user has viewed the advertisement.

Furthermore, the information processing system 1 may set a view time for each advertisement. For example, the information processing system 1 may extract an advertisement from the subjective image, and if the line-of-sight position has been contained in the area containing the extracted advertisement for a longer time than the view time set for the advertisement, the information processing system 1 may determine that the user has viewed the extracted advertisement. By performing the above described process, even when an advertisement containing a number of characters or an advertisement containing no character are mixed, the information processing system 1 can determine that the user has viewed an advertisement whose contents are likely to be understood by the user.

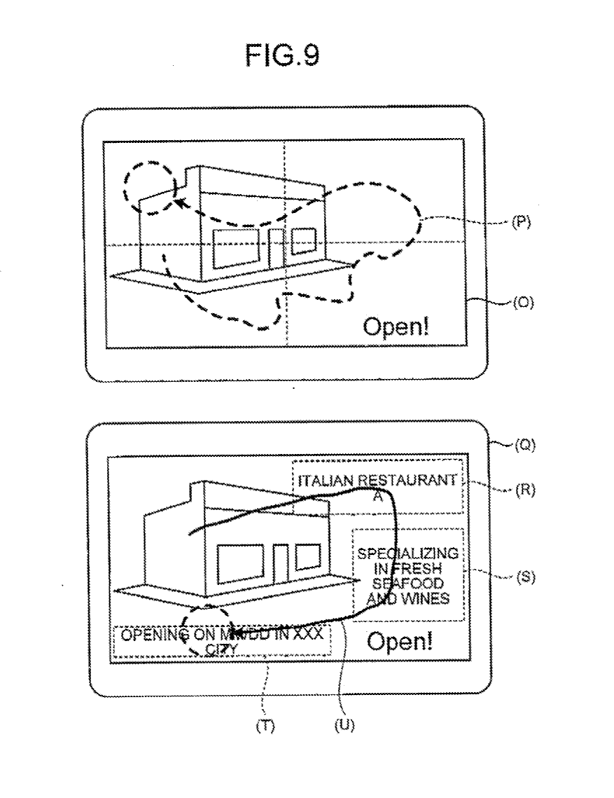

Furthermore, the information processing system 1 may divide an advertisement into a plurality of areas, and if the line-of-sight position of the user is contained in each of the divided areas of the advertisement, the information processing system 1 may determine that the user has viewed the advertisement. For example, FIG. 9 is a diagram for explaining a modified example of the process of detecting an advertisement viewed by the user. For example, the information processing system 1 detects an advertisement from the subjective image by using the advertisement detection data. Then, the information processing system 1 divides the detected advertisement into four areas as illustrated in (O) in FIG. 9.

Thereafter, the information processing system 1 determines whether the line-of-sight position indicated by the line-of-sight information is contained in each of the divided areas of the advertisement by using the sequentially acquired subjective images and pieces of line-of-sight information. For example, if the sequentially acquired pieces of the line-of-sight information have moved as illustrated in (P) in FIG. 9 and the line-of-sight positions are contained in all of the divided areas of the advertisement, the information processing system 1 determines that the use has viewed the advertisement illustrated in (O) in FIG. 9.

Furthermore, the information processing system 1 may set one or more areas desired to be viewed by the user in the advertisement, and if the line-of-sight positions are contained in all of the set areas, the information processing system 1 may determine that the user has viewed the advertisement. For example, in the advertisement illustrated in (Q) in FIG. 9, three areas containing characters as illustrated in (R), (S), and (T) in FIG. 9 are set as areas desired to be viewed by the user. In this case, if the line-of-sight positions indicated by a plurality of pieces of the line-of-sight information acquired from the user have moved as illustrated in (U) in FIG. 9 and the line-of-sight positions are contained in all of the areas illustrated in (R), (S), and (T) in FIG. 9, the information processing system 1 determines that the user has viewed the advertisement illustrated in (Q) in FIG. 9.

Furthermore, if the user has viewed each of parts of the same type of an advertisement provided in different locations and therefore viewed the entire area of the advertisement within a predetermined time, the information processing system 1 may determine that the user has viewed the advertisement. For example, when the user has viewed only a part of the advertisement, the information processing system 1 stores, as a view history, the area viewed by the user. Then, when the view histories are integrated and if the user has viewed all of the areas set in the advertisement indicated by the same advertisement ID, the information processing system 1 may determine that the user has viewed the advertisement.

A specific example will be described. For example, if the user has viewed the advertisement illustrated in (Q) in FIG. 9 in the street but has viewed only the area illustrated in (R) in FIG. 9 without viewing the areas illustrated in (S) and (T) in FIG. 9, the information processing system 1 stores, as a view history, the advertisement ID of the advertisement illustrated in (Q) in FIG. 9 and the area illustrated in (R) in FIG. 9. Furthermore, if the user has viewed the advertisement illustrated in (Q) in FIG. 9 in a newspaper and viewed the areas illustrated in (S) and (T) in FIG. 9, the information processing system 1 stores, as a view history, the advertisement ID of the advertisement illustrated in (Q) in FIG. 9 and the areas illustrated in (S) and (T) in FIG. 9.

As a result of the above processes, the information processing system 1 can determine that the user has viewed the entire advertisement illustrated in (Q) in FIG. 9 by integrating the view histories. As a result, for example, when it is possible to determine that the user has understood the contents of an advertisement because the user has repeatedly viewed the advertisement in the same place at different times, or when it is possible to determine that the user has understood the contents of the advertisement because the user has viewed the same type of advertisements in different locations at different times, the information processing system 1 can determine that the user has viewed the advertisement.

If the line-of-sight position is contained for a longer time than a predetermined time in each area of the advertisement, the information processing system 1 may determine that the user has viewed the advertisement. Furthermore, the information processing system 1 may store, as a view history, a time in which the user has viewed the advertisement, and if a total time in which the user has viewed the advertisement becomes greater than a predetermined threshold within a predetermined time, the information processing system 1 may determine that the user has viewed the advertisement. By performing the above described process, the information processing system 1 can determine whether the user has repeatedly viewed the advertisement in different locations at different times and has understood the contents of the advertisement. Furthermore, the information processing system 1 may perform an arbitrary combination of the above described processes and determine whether the user has viewed the advertisement whose contents are likely to be surely understood by the user.

### 4-2. Modified Example of Process of Detecting Shop Visited by User

In the above described example, the information processing system 1 detects a shop by using face authentication, a QR code, or the like. However, the embodiment is not limited to this example. For example, the information processing system 1 may store, as the shop detection data, data for detecting a scene in the shop, a scene beside a cash register, or the like, and may detect a shop visited by the user from the subjective image by using the shop detection data.

Furthermore, the information processing system 1 may detect a shop visited by the user by using shop detection data for detecting a signboard, menu, logo, exterior, or the like of the shop. Namely, the information processing system 1 can detect a shop by using arbitrary data as long as the data is the shop detection data for detecting, from the subjective image, a scene to be viewed by the user who has visited the shop.

Furthermore, the information processing system 1 detects that the user has visited the shop when detecting a signboard of the shop or an exterior of the shop from the subjective image, and determines that the user has purchased goods in the shop when detecting a face of a shop staff of the shop. Then, the information processing system 1 may calculate, for each shop, the number of visited users, the number of users who have been induced to visit the advertised shop by the advertisement, and the number of users who have been induced to visit the advertised shop by the advertisement and have purchased goods related to the advertisement in the advertised shop, and evaluate the advertising effectiveness or calculate an advertisement fee by using the information on the calculated numbers.

Furthermore, the information processing system 1 may not detect a shop visited by the user from the subjective image. For example, the information processing system 1 may acquire information on a shop visited by the user from a history of a credit card usage or electronic money usage, global positioning system (GPS), or a system that manages a check-in function using a communication history or the like of a terminal device of the user.

### 4-3. Modified Example of Process of Determining Whether Advertisement Induced User to Visit Shop

In the above described example, when the view time at which the user viewed an advertisement is earlier than the visit time at which the user visited a shop that is an advertised shop in the advertisement, the information processing system 1 determines that the advertisement induced the user to visit the shop. However, the embodiment is not limited to this example. For example, the information processing system 1 may determine that an advertisement induced the user to visit a shop only when the view time is earlier than the shop visit time and a difference between the view time and the shop visit time is less than a predetermined time. For example, the information processing system 1 may determine that the advertisement induced the user to visit the shop when a difference between the view time and the shop visit time is equal to or less than a few days, and may determine that the advertisement has not induced the user to visit the shop when a difference between the view time and the shop visit time is equal to or more than a few days.

### 5. Modified Example

The information processing system 1 according to the above described embodiment may be embodied in various forms other than the above described embodiment. Therefore, other embodiments of the above described information processing system 1 will be described below.

### 5-1. Subject of Processes

In the above described embodiment, the information processing system 1 includes the head mounted device 10 that acquires subjective images of the user and transmits the acquired subjective images as image logs to the processing server 30, and includes the processing server 30 that detects advertisements from the subjective images. However, the embodiment is not thus limited. Namely, each of the processes performed by the information processing system 1 may be performed by any of the head mounted device 10 and the processing server 30.

For example, the head mounted device 10 includes the advertisement database 34, the shop database 35, the advertisement detection unit 38, and the shop detection unit 39 illustrated in FIG. 3, and detects an advertisement viewed by the user and a shop visited by the user from a subjective image of the user. Then, the head mounted device 10 transmits the advertisement viewed by the user and the shop visited by the user to the processing server 30. Meanwhile, upon receiving a notice on the advertisement viewed by the user and the shop visited by the user from the head mounted device 10, the processing server 30 performs matching of the advertisement and the shop and determines whether the advertisement induced the user to visit the shop.

Furthermore, the head mounted device 10 stores view histories, and when determining that the user has viewed the advertisement as a result of viewing the advertisement a number of times, notifies the processing server 30 of the advertisement as the advertisement viewed by the user.

### 5-2. Calculation of Effect of Sending Customer by the Advertisement

In the above described embodiment, the information processing system 1 evaluates the effect of sending customer by the advertisement by using the number of users who have visited a shop and the number of users who have been induced to visit an advertised shop by an advertisement. However, the embodiment is not thus limited. For example, the information processing system 1 may collect information on the users who have been induced to visit the advertised shop by the advertisement, and evaluate a type of users for which the advertisement can be effective, based on the collected information.

Furthermore, when detecting an advertisement from a subjective image, the information processing system 1 may specify a location in which the user has viewed the advertisement by using a technology, such as GPS, and evaluate a line-of-sight inducing effect of the advertisement based on the specified location. Furthermore, for example, when detecting an advertisement from a subjective image, the information processing system 1 collects biological information on the user at the time of viewing the advertisement, and specifies a feeling of the user at the time of the advertisement by using the collected biological information. Then, the information processing system 1 may determine the impression that the advertisement has given to the user based on the specified feeling. Namely, the information processing system 1 can evaluate the advertisement or calculate an advertisement fee by combining information on the advertisement viewed by the user and arbitrary information.

### 5-3. Advertisement

The information processing system 1 detects an advertisement from a subjective image by using the advertisement detection data. The advertisement is not limited to still images, such as electronic screens, signboards, photographs, or posters, provided in public spaces but may be moving images, still images such as photographs or posters, information provided on exteriors of goods, mannequins or goods of mascot characters, advertised goods themselves, or the like.

For example, the information processing system 1 stores the advertisement detection data for specifying a predetermined vehicle from a subjective image, and when detecting the vehicle from the subjective image of the user, determines that the user has viewed the vehicle. Furthermore, when detecting a dealer that sells the vehicle from the subjective image of the user, the information processing system 1 determines that the user has visited the dealer as a result of viewing the vehicle. The information processing system 1 may evaluate a type of users with whom the vehicle is popular based on information on the users who have visited the dealer as a result of viewing the vehicle. Furthermore, the information processing system 1 may evaluate a type of users with whom the advertisement is popular based on information on users who have viewed the advertisement, without detecting a shop.

Furthermore, if the advertisement is a signage advertisement, such as a digital signage, a plurality of advertisements is displayed on a single medium. However, the information processing system 1 can detect an advertisement viewed by the user. Therefore, even when a plurality of advertisements is displayed on a single medium, it is possible to calculate the number of users who have been induced to visit a shop for each advertisement. As a result, the information processing system 1 can calculate an advertisement fee for the advertisement displayed in various modes, based on an actual inducing effect.

### 5-4. Others

The functions implemented by the head mounted device 10 and the processing server 30 as described above may be realized by a plurality of servers by using a so-called cloud function. For example, the functions implemented by the advertisement detection unit 38, the shop detection unit 39, the determination unit 40, and the calculation unit 41 may be realized by different server devices. Furthermore, the advertisement database 34, the shop database 35, the advertisement view table 36, and the shop usage table 37 may be stored in different server devices. Moreover, the functions implemented by the advertisement detection unit 38, the shop detection unit 39, the determination unit 40, the calculation unit 41 may be integrated or separated in arbitrary forms. Furthermore, an arbitrary device may be employed as the head mounted device 10 as long as the device can implement functions of squiring subjective images of the user and displaying various types of information in the field of view of the user.

Of the processes described in the embodiments, all or part of a process described as being performed automatically may also be performed manually. Alternatively, all or part of a process described as being performed manually may also be performed automatically by known methods. In addition, the processing procedures, specific names, and information including various types of data and parameters illustrated in the above-described document and drawings may be arbitrarily changed unless otherwise specified. For example, various types of information illustrated in the drawings are not limited to those illustrated in the drawings. Furthermore, for example, user interfaces (UIs) of applications illustrated in the drawings are not limited to those illustrated in the drawings.

The components illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

### 6. Flow of Processes Performed by the Information Processing System 1

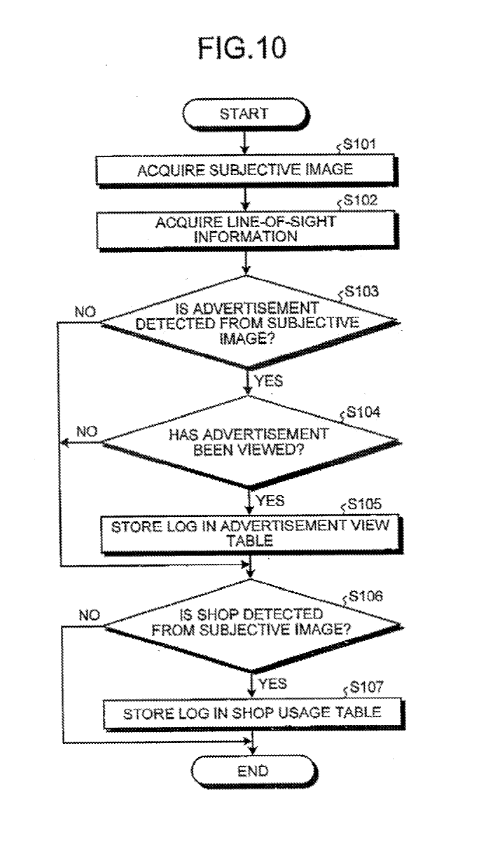

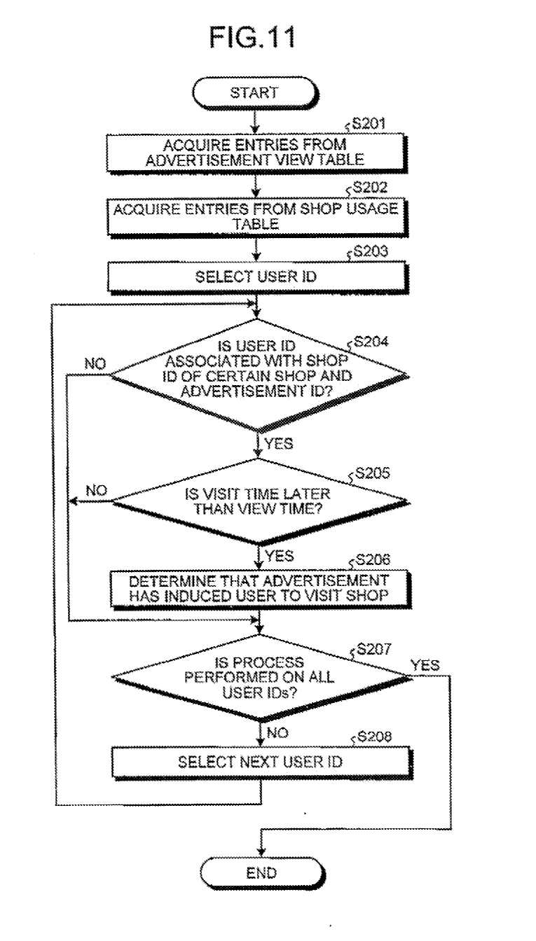

Examples of the flow of processes performed by the information processing system 1 will be described below with reference to FIG. 10 and FIG. 11. First, the flow of a process of detecting an advertisement and a shop from a subjective image of the user by the information processing system 1 will be described with reference to FIG. 10. FIG. 10 is a flowchart for explaining the flow of a detection process performed by the information processing system according to the embodiment.

First, the information processing system 1 acquires a subjective image (Step S101). Furthermore, the information processing system 1 acquires line-of-sight information (Step S102). Subsequently, the information processing system 1 performs an image recognition process by using the advertisement detection data, and determines whether an advertisement is detected from the subjective image (Step S103).

If the advertisement is detected from the subjective image (Step S103: Yes), the information processing system 1 determines whether the user has viewed the advertisement by using the line-of-sight information (Step S104). If the user has viewed the advertisement (Step S104: Yes), the information processing system 1 stores a log in the advertisement view table 36 (Step S105).

The information processing system 1 performs an image recognition process by using the shop detection data, and determines whether a shop is detected from the subjective image (Step S106). If the shop is detected from the subjective image (Step S106: Yes), the information processing system 1 stores a log in the shop usage table 37 (Step S107), and ends the process.

If the advertisement is not detected from the subjective image (Step S103: No), or if the user has not viewed the advertisement (Step S104: No), the information processing system 1 performs a process at Step S106. Furthermore, if the shop is not detected from the subjective image (Step S106: No), the information processing system 1 skips Step S107 and ends the process.

Next, the flow of a process of performing matching of the advertisement view table 36 and the shop usage table 37 by the information processing system 1 will be described with reference to FIG. 11 FIG. 11 is a flowchart for explaining the flow of matching performed by the information processing system according to the embodiment. First, the information processing system 1 acquires each of entries stored in the advertisement view table 36 (Step S201). Furthermore, the information processing system 1 acquires each of entries stored in the shop usage table 37 (Step S202).

Subsequently, the information processing system 1 selects one user ID (Step S203), and determines whether the selected user ID is associated with a shop ID of a certain shop and an advertisement ID of an advertisement associated with this shop (Step S204). If the selected user ID is associated with the shop ID and the advertisement ID (Step S204: Yes), the information processing system 1 determines whether a shop visit time associated with the shop ID is later than a view time associated with the advertisement ID (Step S205).

If the shop visit time is later than the view time (Step S205: Yes), the information processing system 1 determines that the advertisement induced the user to visit the advertised shop (Step S206). Subsequently, the information processing system 1 determines whether the process from Steps S204 to S206 is performed on all of the user IDs (Step S207). If the process is not performed on all of the user IDs (Step S207: No), the information processing system 1 selects a next user ID (Step S208), and performs a process at Step S204.

If the selected user ID is not associated with a shop ID of a certain shop and an advertisement ID of an advertisement associated with this shop (Step S204: No), the information processing system 1 performs a process at Step S207. Furthermore, if the shop visit time associated with the shop ID is earlier than the view time associated with the advertisement ID (Step S205: No), the information processing system 1 performs a process at Step S207. Moreover, if the process from Steps S204 to S206 is performed on all of the user IDs (Step S207: Yes), the information processing system 1 ends the process.

### 7. Advantageous Effects

As described above, the information processing system 1 acquires a subjective image corresponding to the field of view of the user, and detects an advertisement viewed by the user from the acquired subjective image. Then, the information processing system 1 stores information on the detected advertisement and the user in an associated manner. Therefore, the information processing system 1 can detect various advertisements viewed by the user while preventing an increase in costs and an invasion of privacy. For example, the information processing system 1 can detect, as advertisements viewed by the user, not only still images on digital signages, printed matters, or the like, but also moving images such as commercials, three-dimensional objects such as mannequins, products such as vehicles.

Furthermore, the information processing system 1 acquires a viewpoint position of the user in a subjective image. The information processing system 1 detects, as an advertisement viewed by the user, an advertisement with respect to which the viewpoint position is contained in the area containing this advertisement, from among advertisements in the subjective image. Therefore, the information processing system 1 can detect only the advertisement viewed by the user.

Moreover, the information processing system 1 detects, as an advertisement viewed by the user, an advertisement with respect to which the viewpoint position of the user is contained for a predetermined time in the area containing this advertisement, from among advertisements in the subjective image. Therefore, the information processing system 1 can detect the advertisement that the user has consciously viewed.

Furthermore, the information processing system 1 detects a shop visited by the user. Then, when the advertisement detected from the subjective image is stored in association with the user, the information processing system 1 determines that the advertisement induced the user to visit the advertised shop. Therefore, the information processing system 1 can evaluate the effect of sending customer by the advertisement.

Moreover, the information processing system 1 stores the shop detection data for detecting a shop from the subjective image. The information processing system 1 detects a shop visited by the user from the subjective image by using the shop detection data. Therefore, the information processing system 1 can specify the shop visited by the user from the subjective image.

Furthermore, the information processing system 1 stores, as the shop detection data, data for performing face authentication on a shop staff. The information processing system 1 performs face authentication on a person contained in the subjective image by using the data for performing face authentication on a shop staff, and when succeeding in the face authentication on the shop staff, detects a shop associated with the authenticated shop staff as a shop visited by the user. Therefore, the information processing system 1 can reliably specify the shop visited by the user.

Moreover, when a difference between a view time at which the advertisement was viewed and a visit time at which the user visited the advertised shop is greater than a predetermined threshold, the information processing system 1 does not determine that the advertisement induced the user to visit the advertised shop. Therefore, the information processing system 1 can prevent false detection in which a user who has visited the shop independent of the advertisement is erroneously detected as the user who has visited the shop as a result of viewing the advertisement.

Moreover, the information processing system 1 calculates the effect of sending customer by the advertisement based on the number of users who have visited the shop and the number of users who have been induced to visit the shop by the advertisement. Therefore, the information processing system 1 can evaluate the effect of sending customer by the advertisement while preventing an increase in costs and an invasion of privacy.

### 8. Program

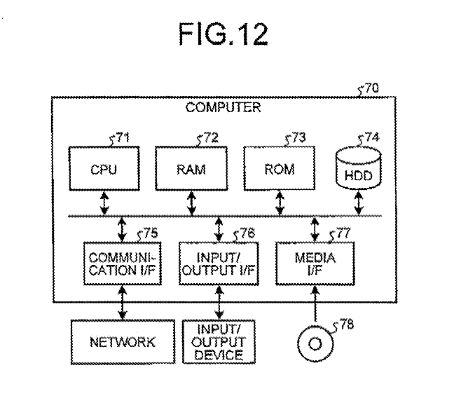

The head mounted device 10 according to the above described embodiments is realized by causing a computer 70 configured as illustrated in FIG. 12 for example to execute information processing program. FIG. 12 is a diagram illustrating an example of a hardware configuration of the computer that executes the information processing program. The computer 70 includes a central processing unit (CPU) 71, a random access memory (RAM) 72, a read only memory (ROM) 73, a hard disk drive (HDD) 74, a communication interface (I/F) 75, an input/output interface (I/F) 76, and a media interface (I/F) 77.

The CPU 71 operates according to programs stored in the ROM 73 or the HDD 74, and controls each unit. The ROM 73 stores therein a boot program executed by the CPU 71 when the computer 70 is activated, a program dependent on hardware of the computer 70, or the like.

The HDD 74 stores therein the information processing program executed by the CPU 71, data used by the information processing program, or the like. For example, the HDD 74 stores therein data similar to the advertisement database 34, the shop database 35, the advertisement view table 35, the shop usage table 37, or the like illustrated in FIG. 3. The communication interface 75 receives data from other devices via a network, transmits the data to the CPU 71, and transmits data generated by the CPU 71 to other devices via a network.

The CPU 71 controls an output device, such as a display or a printer, and an input device, such as a keyboard or a mouse, via the input/output interface 76. The CPU 71 acquires data from the input device via the input/output interface 76. The CPU 71 outputs generated data to the output device via the input/output interface 76.

The media interface 77 reads programs or data stored in a recording medium 78, and provides the programs or data to the CPU 71 via the RAM 72. The CPU 71 loads the programs from the recording medium 78 to the RAM 72 via the media interface 77, and executes the loaded programs. The recording medium 78 is, for example, an optical recording medium such as a digital versatile disk (DVD) or a phase change rewritable disk (PD), a magneto optical recording medium such as a magneto-optical (MO) disk, a tape medium, a magnetic recording medium, a semiconductor memory, or the like.

When the computer 70 functions as the above described head mounted device 10 according to the embodiment, the CPU 71 of the computer 70 executes the program loaded on the RAM 72 and implements the functions of the advertisement detection unit 38, the shop detection unit 39, the determination unit 40, and the calculation unit 41.

The CPU 71 of the computer 70 reads the information processing program from the recording medium 78 and executes the read information processing program. However, as another example, it may be possible to acquire the program from other devices via the network.

According to an embodiment, it becomes possible to detect an advertisement viewed by a user while preventing an increase in costs and an invasion of privacy.

Although the invention has been described with respect to specific embodiments for a complete and disclosure, the appended claims are not to be thus limited but are to be construed as embodying all modifications and alternative constructions that may occur to one skilled in the art that fairly fall within the basic teaching herein set forth.

What is claimed is:

1. An information processing system comprising:
an image acquisition unit that acquires a captured image corresponding to a field of view of a user;
an advertisement detection unit that detects an advertisement viewed by the user from the captured image; and
a storage unit that stores therein information of the detected advertisement in association with the user.

2. The information processing system according to claim 1, further comprising:
a viewpoint acquisition unit that acquires a viewpoint position of the user in the captured image, wherein
the advertisement detection unit that detects an advertisement, containing the viewpoint position in an area containing the advertisement, from among advertisements contained in the captured image.

3. The information processing system according to claim 2, wherein the advertisement detection unit detects an advertisement, containing the viewpoint position in the area containing the advertisement until a predetermined time is passed, from among the advertisements contained in the captured image.

4. The information processing system according to claim 1, further comprising:
a shop detection unit that detects a shop visited by the user; and
a determination unit that determines, when the information of the detected advertisement stored in the storage unit is information of an advertisement related to the visited shop detected by the shop detection unit, the detected advertisement induced the user to visit the shop.

5. The information processing system according to claim 4, further comprising:
a shop storage unit that stores therein shop identification information for identifying the shop from the captured image; wherein
the shop detection unit detects the shop visited by the user from the captured image by using the shop identification information.

6. The information processing system according to claim 5, wherein
the shop storage unit stores therein information for performing face authentication on a shop staff, and
the shop detection unit performs face authentication on the shop staff from the captured image by using the information for performing face authentication on the shop staff, and detects, when succeeding in the face authentication on the shop staff, a shop associated with the authenticated shop staff as the shop visited by the user.

7. The information processing system according to claim 4, wherein
when the information of the advertisement stored in the storage unit corresponds to an advertisement related to the shop visited by the user and a difference, between a time of acquiring the captured image which the advertisement is detected and a time of visiting the shop related to the advertisement by the user, is greater than a threshold, the determination unit does not determine that the advertisement induced the user to visit the shop.

8. The information processing system according to claim 4, further comprising a calculation unit that calculates an effect by the advertisement based on the number of users who visited the shop and the number of users who was induced to visit the shop by the advertisement related to the shop.

9. An information processing method performed by an information processing system including a terminal device and an information processing apparatus capable of communicating with the terminal device, the information processing method comprising:
acquiring a captured image corresponding to a field of view of a user; and
detecting an advertisement viewed by the user from the captured image.

10. The information processing method according to claim 9, wherein:
the acquiring includes acquiring a viewpoint position of the user in the captured image, and
the detecting includes detecting an advertisement, containing the viewpoint position in an area containing the advertisement, from among advertisements contained in the captured image.

11. The information processing method according to claim 10, wherein the detecting includes detecting an advertisement, containing the viewpoint position in the area containing the advertisement until a predetermined time is passed, from among the advertisements contained in the captured image.

12. The information processing method according to claim 9, wherein:
the detecting includes detecting a shop visited by the user; further comprising
a determining that, when the detected advertisement is an advertisement related to the visited shop, the detected advertisement induced the user to visit the shop.

13. The information processing method according to claim 12, wherein:
the detecting includes detecting a shop visited by the user from the captured image by using a shop identification information for identifying the shop from the captured image.

14. The information processing method according to claim 13, further comprising
performing face authentication on a shop staff from the captured image by using information for performing face authentication on the shop staff, wherein
the detecting includes detecting, when succeeding in the face authentication on the shop staff, a shop associated with the authenticated shop staff as the shop visited by the user.

15. The information processing method according to claim 12, wherein
the determining includes determining, when the detected advertisement corresponds to an advertisement related to the shop visited by the user and a difference, between a time of acquiring the captured image which the advertisement is detected and a time of visiting the shop related to the advertisement by the user, is greater than a threshold, the advertisement does not induce the user to visit the shop.

16. The information processing method according to claim 12, further comprising a calculating an effect by the advertisement based on the number of users who visited the shop and the number of users who was induced to visit the shop by the advertisement related to the shop.

17. A non-transitory computer readable storage medium having stored therein an information processing program causing a computer to execute a process, the process comprising:
acquiring a captured image corresponding to a field of view of a user; and
detecting an advertisement viewed by the user from the captured image.

18. The non-transitory computer readable storage medium according to claim 17, wherein:
the acquiring includes acquiring a viewpoint position of the user in the captured image, and
the detecting includes detecting an advertisement, containing the viewpoint position in an area containing the advertisement, from among advertisements contained in the captured image.

19. The non-transitory computer readable storage medium according to claim 18, wherein the detecting includes detecting am advertisement, containing the viewpoint position in the area containing the advertisement until a predetermined time is passed, from among the advertisements contained in the captured image.

20. The non-transitory computer readable storage medium according to claim 17, wherein:
the detecting includes detecting a shop visited by the user; further comprising
a determining that, when the detected advertisement is an advertisement related to the visited shop, the detected advertisement induced the user to visit the shop.

21. The non-transitory computer readable storage medium according to claim 20, wherein:
the detecting includes detecting a shop visited by the user from the captured image by using a shop identification information for identifying the shop from the captured image.

22. The non-transitory computer readable storage medium according to claim 21, further comprising
performing face authentication on a shop staff from the captured image by using information for performing face authentication on the shop staff, wherein
the detecting includes detecting, when succeeding in the face authentication on the shop staff, a shop associated with the authenticated shop staff as the shop visited by the user.

23. The non-transitory computer readable storage medium according to claim 20, wherein
the determining includes determining, when the detected advertisement corresponds to an advertisement related to the shop visited by the user and a difference, between a time of acquiring the captured image which the advertisement is detected and a time of visiting the shop related to the advertisement by the user, greater than a threshold, the advertisement does not induce the user to visit the shop.

24. A The non-transitory computer readable storage medium according to claim 20, further comprising a calculating an effect by the advertisement based on the number of users who visited the shop and the number of users who was induced to visit the shop by the advertisement related to the shop.
